(19) United States
(12) Patent Application Publication
(10) Pub. No.: US 2017/0004920 A1
(43) Pub. Date: Jan. 5, 2017

(54) MAGNETIC COMPONENT AND METHOD OF MANUFACTURING MAGNETIC COMPONENT

(71) Applicant: CYNTEC CO., LTD., Hsinchu (TW)

(72) Inventors: Ming-Tsung Pan, Hsinchu (TW); Hsieh-Shen Hsieh, Hsinchu (TW); Chu-Keng Lin, Hsinchu (TW)

(21) Appl. No.: 15/081,953

(22) Filed: Mar. 28, 2016

Related U.S. Application Data
(60) Provisional application No. 62/186,380, filed on Jun. 30, 2015.

(51) Int. Cl. H01F 27/32; H01F 41/076; H01F 41/12; H01F 27/29; H01F 27/28

(52) U.S. Cl. CPC H01F 27/324; H01F 27/29; H01F 27/2885; H01F 41/122; H01F 41/076

(57) ABSTRACT

A magnetic component includes a first core, a supporting base, at least one winding, at least one insulation member and a second core. The first core has an accommodating space. The supporting base is disposed in the accommodating space and the supporting base has an electrode platform. The at least one winding is disposed in the accommodating space and stacked on the supporting base, wherein a winding end of the at least one winding is disposed on a connecting portion of the electrode platform. The at least one insulation member is disposed in the accommodating space and stacked on the at least one winding. The second core is disposed on the first core and covers the accommodating space.

### CROSS REFERENCE TO RELATED APPLICATIONS

This application claims the benefit of U.S. Provisional Application No. 62/186,380, which was filed on Jun. 30, 2015, and is incorporated herein by reference.

### BACKGROUND OF THE INVENTION

1. Field of the Invention

The invention relates to a magnetic component and a method of manufacturing the magnetic component and, more particularly, to a magnetic component with stacked winding and insulation member and a method of manufacturing the magnetic component.

2. Description of the Related Art

A magnetic component is an important electric component used for storing energy, converting energy and isolating electricity. In most of circuits, there is always a magnetic component installed therein. In general, the magnetic component mainly comprises a transformer and an inductor and the magnetic component usually consists of at least one winding and a core. For example, the transformer may have at least one primary winding and a secondary winding disposed in a core while the inductor may have one single winding disposed in a core. In the prior art, the winding is wound around a pillar of the core manually and a winding end of the winding is also wound around a connecting pin manually, such that the magnetic component cannot be manufactured automatically. Consequently, the manufacture cost will increase and the manufacture efficiency will decrease.

### SUMMARY OF THE INVENTION

The invention provides a magnetic component with stacked winding and insulation member and a method of manufacturing the magnetic component, so as to solve the aforesaid problems.

According to an embodiment of the invention, a magnetic component comprises a first core, a supporting base, at least one winding, at least one insulation member and a second core. The first core has an accommodating space. The supporting base is disposed in the accommodating space and the supporting base has an electrode platform. The at least one winding is disposed in the accommodating space and stacked on the supporting base, wherein a winding end of the at least one winding is disposed on a connecting portion of the electrode platform. The at least one insulation member is disposed in the accommodating space and stacked on the at least one winding. The second core is disposed on the first core and covers the accommodating space.

According to another embodiment of the invention, a method of manufacturing a magnetic component comprises steps of providing a first core, a supporting base, at least one winding, at least one insulation member and a second core, wherein the first core has an accommodating space and the supporting base has an electrode platform; disposing the supporting base in the accommodating space; stacking the at least one winding and the at least one insulation member on the supporting base interlacedly and disposing a winding end of the at least one winding on a connecting portion of the electrode platform; and disposing the second core on the first core, wherein the second core covers the accommodating space.

As mentioned in the above, the invention disposes the supporting base in the accommodating space of the core and stacks the winding and the insulation member on the supporting base interlacedly. Since the winding and the insulation member are stacked on the supporting base rather than being wound around a pillar of the core, the winding and the insulation member can be formed in advance and the magnetic component of the invention can be manufactured automatically. Furthermore, when the winding is stacked on the supporting base, the winding end of the at least one winding is disposed and fixed on the connecting portion of the electrode platform, so as to form an electrical connection. Since the winding end of the winding is disposed and fixed on the connecting portion of the electrode platform to form an electrical connection, automation of manufacturing the magnetic component can be achieved easily and effectively. Consequently, the manufacture cost can decrease and the manufacture efficiency can increase.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a magnetic component according to an embodiment of the invention.

FIG. 2 is an exploded view illustrating the magnetic component shown in FIG. 1.

FIG. 3 is an enlarged view illustrating the supporting base shown in FIG. 2.

FIG. 4 is a perspective view illustrating the windings, the shielding members and the insulation members shown in FIG. 2 stacked on the supporting base interlacedly.

FIG. 5 is a cross-sectional view illustrating the windings, the shielding members and the insulation members stacked on the supporting base 12 interlacedly.

FIG. 6 is a perspective view illustrating the winding ends of the windings and the connecting ends of the shielding members fixed on the connecting portions of the electrode platform shown in FIG. 2 by solder.

FIG. 7 is a perspective view illustrating the supporting base disposed in the accommodating space of the first core shown in FIG. 2.

FIG. 8 is a flowchart illustrating a method of manufacturing the magnetic component shown in FIG. 1.

FIG. 9 is a perspective view illustrating a magnetic component according to another embodiment of the invention.

FIG. 10 is a perspective view illustrating a magnetic component according to another embodiment of the invention.

FIG. 11 is a perspective view illustrating a magnetic component according to another embodiment of the invention.

FIG. 12 is a perspective view illustrating the magnetic component shown in FIG. 11 from another viewing angle.

FIG. 13 is a perspective view illustrating a magnetic component according to another embodiment of the invention.

FIG. 14 is a perspective view illustrating the magnetic component shown in FIG. 13 before the pins are pressed downwardly.

FIG. 15 is a perspective view illustrating a magnetic component according to another embodiment of the invention.

FIG. 16 is a schematic view illustrating eight types of windings.

FIG. 17 is a schematic view illustrating two types of shielding members.

FIG. 18 is a cross-sectional view illustrating a magnetic component according to another embodiment of the invention.

FIG. 19 is an equivalent circuit schematic illustrating the primary windings connected in parallel.

FIG. 20 is an equivalent circuit schematic illustrating the primary windings connected in series.

FIG. 21 is a cross-sectional view illustrating the windings, the shielding members and the insulation members stacked on the supporting base interlacedly according to another embodiment of the invention.

### DETAILED DESCRIPTION

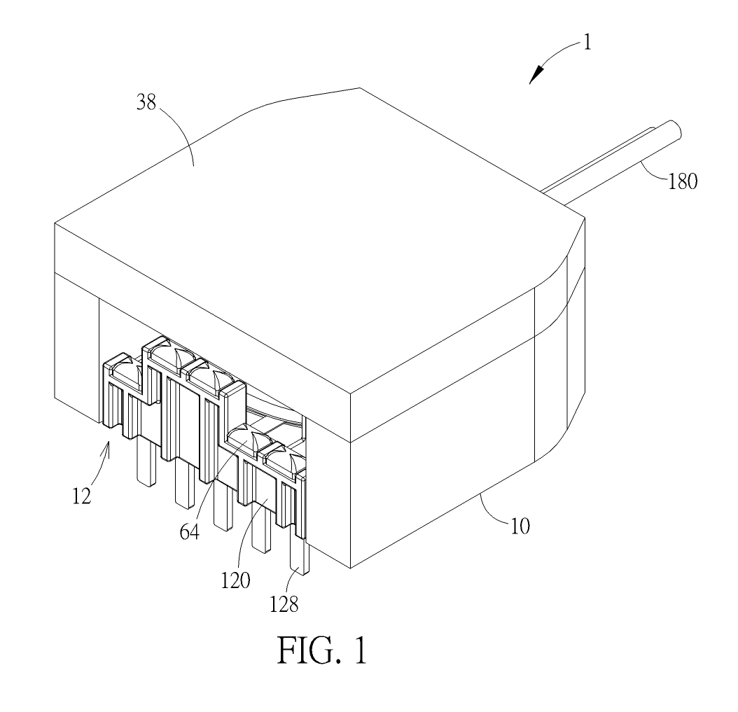

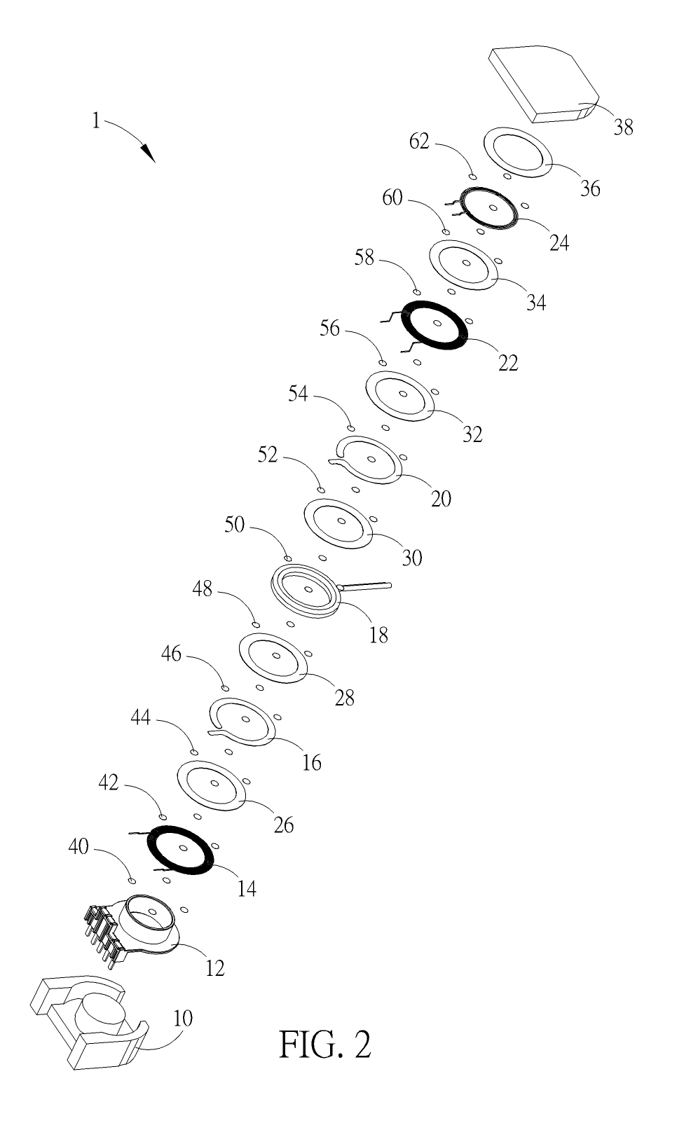

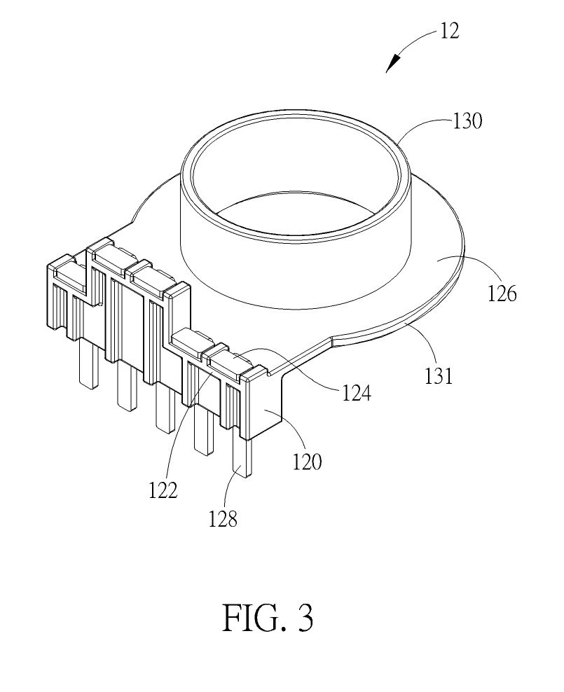

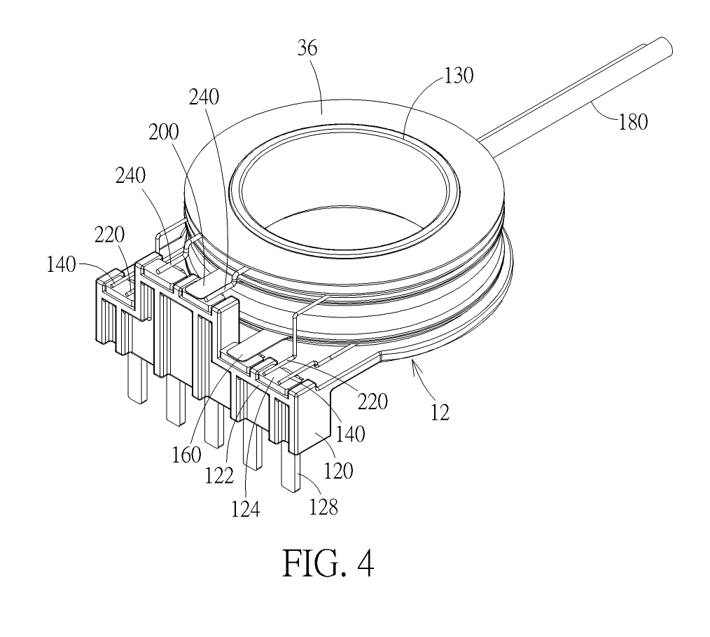

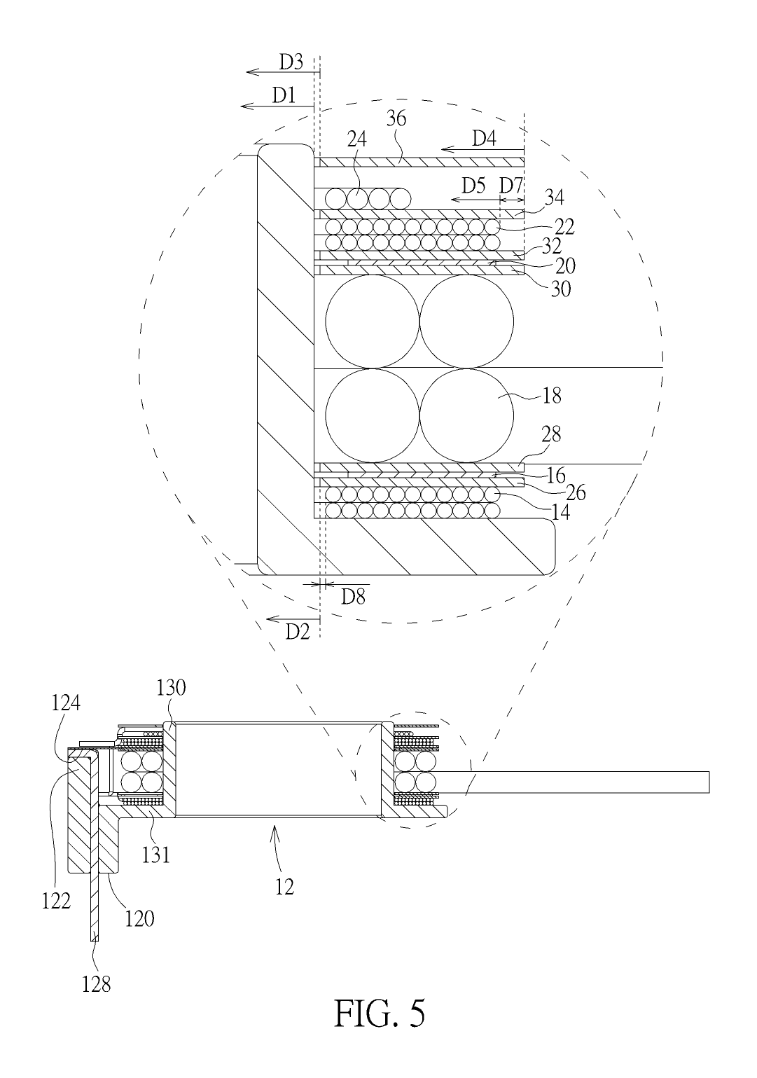

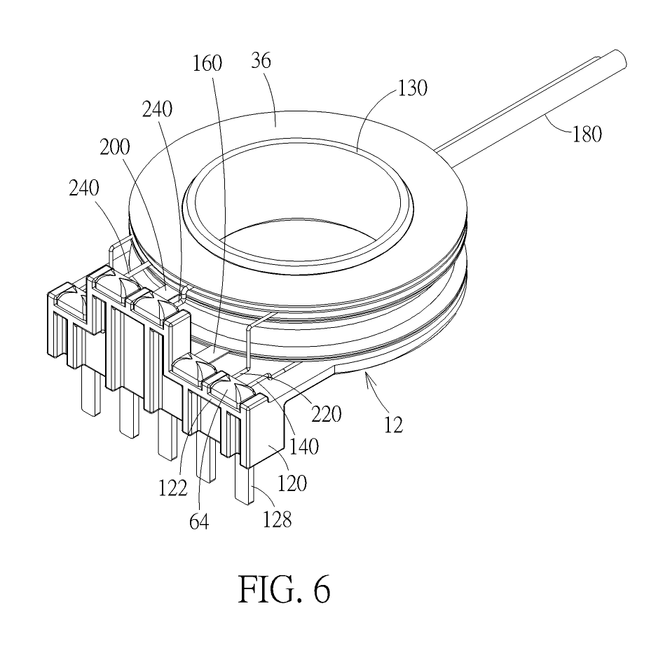

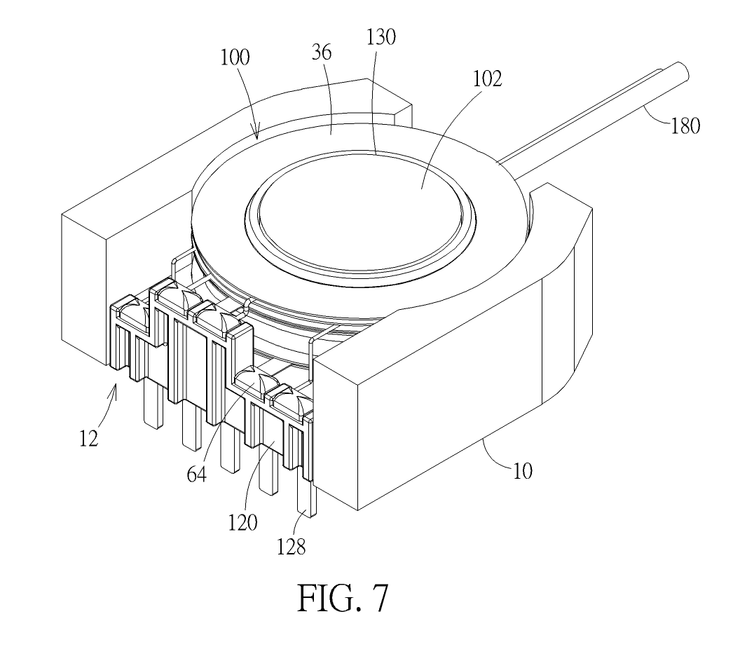

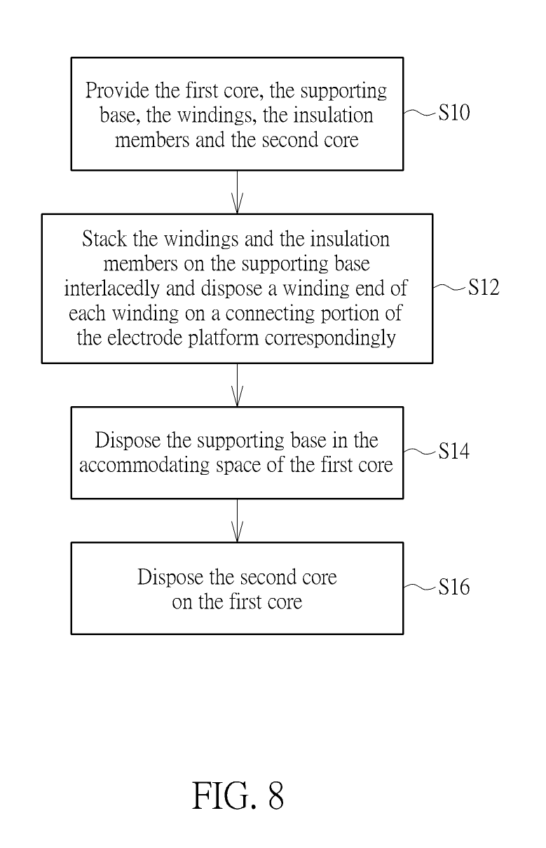

Referring to FIGS. 1 to 8, FIG. 1 is a perspective view illustrating a magnetic component 1 according to an embodiment of the invention, FIG. 2 is an exploded view illustrating the magnetic component 1 shown in FIG. 1, FIG. 3 is an enlarged view illustrating the supporting base 12 shown in FIG. 2, FIG. 4 is a perspective view illustrating the windings 14, 18, 22, 24, the shielding members 16, 20 and the insulation members 26, 28, 30, 32, 34, 36 shown in FIG. 2 stacked on the supporting base 12 interlacedly, FIG. 5 is a cross-sectional view illustrating the windings 14, 18, 22, 24, the shielding members 16, 20 and the insulation members 26, 28, 30, 32, 34, 36 stacked on the supporting base 12 interlacedly, FIG. 6 is a perspective view illustrating the winding ends 140, 220, 240 of the windings 14, 22, 24 and the connecting ends 160, 200 of the shielding members 16, 20 fixed on the connecting portions 122 of the electrode platform 120 shown in FIG. 2 by solder, FIG. 7 is a perspective view illustrating the supporting base 12 disposed in the accommodating space 100 of the first core 10 shown in FIG. 2, and FIG. 8 is a flowchart illustrating a method of manufacturing the magnetic component 1 shown in FIG. 1.

The magnetic component 1 of the invention may be a transformer, an inductor or other magnetic components. As shown in FIGS. 1 and 2, in this embodiment, the magnetic component 1 is taken to be a transformer for illustration purpose, so the magnetic component 1 comprises a first core 10, a supporting base 12, a plurality of windings 14, 18, 22, 24, a plurality of shielding members 16, 20, a plurality of insulation members 26, 28, 30, 32, 34, 36, and a second core 38. However, if the magnetic component 1 is an inductor, the magnetic component 1 may comprise one single winding (i.e. one single equivalent winding formed by plural windings connected in serial or in parallel with each other) and one single insulation member. In other words, the magnetic component 1 of the invention may comprise at least one winding and at least one insulation member according to practical applications.

To manufacture the magnetic component 1, first of all, step S10 shown in FIG. 8 is performed to provide the first core 10, the supporting base 12, the windings 14, 18, 22, 24, the shielding members 16, 20, the insulation members 26, 28, 30, 32, 34, 36 and the second core 38, wherein the first core 10 has an accommodating space 100 and the supporting base 12 has an electrode platform 120. In this embodiment, the electrode platform 120 comprises a plurality of connecting portions 122 and the connecting portions 122 are arranged in a T-shaped type, i.e. some of the connecting portions 122 upwardly protrude from the electrode platform 120, such that the heights of at least two connecting portions 122 are different from each other, as shown in FIG. 3. Furthermore, a contact surface 124 of each connecting portion 122 is parallel to a bottom surface 126 of the supporting base 12. Still further, each of the connecting portions 122 has a pin 128 extending downwardly out of the first core 10. In practical applications, the pin 128 of each connecting portion 122 is used to be installed on a circuit board (not shown). It should be noted that the contact surface 124 of each connecting portion 122 is provided by the other end of the pin 128.

In this embodiment, the windings 14, 18, 22, 24 comprises two primary windings 14, 22, a secondary winding 18 and an auxiliary winding 24. The shielding member 16 is disposed between the primary winding 14 and the secondary winding 18 and the other shielding member 20 is disposed between the primary winding 22 and the secondary winding 18, wherein the shielding members 16, 20 are used for shielding Electromagnetic interference (EMI) between two groups of windings, for example, between a first group of the secondary winding 18 and a second group of the primary windings 14, 22 and the auxiliary winding 24 to reduce EMI coupling. Furthermore, the insulation member 26 is disposed between the primary winding 14 and the shielding member 16, the insulation member 28 is disposed between the shielding member 16 and the secondary winding 18, the insulation member 30 is disposed between the secondary winding 18 and the shielding member 20, the insulation member 32 is disposed between the shielding member 20 and the primary winding 22, the insulation member 34 is disposed between the primary winding 22 and the auxiliary winding 24, and the insulation member 36 is disposed between the auxiliary winding 24 and the second core 38, wherein the insulation members 26, 28, 30, 32, 34, 36 are used for insulation purpose. In practical applications, the insulation members 26, 28, 30, 32, 34, 36 maybe Kapton tapes (films) or other insulating materials. Moreover, the primary windings 14, 22 and/or secondary winding 18 may be made of a triple insulated (triple coating layer) wire, so as to enhance the insulating effect.

After step S10 shown in FIG. 8, step S12 shown in FIG. 8 is performed to stack the windings 14, 18, 22, 24, the shielding members 16, 20 and the insulation members 26, 28, 30, 32, 34, 36 on the supporting base 12 interlacedly and dispose a winding end of each winding 14, 22, 24 and a connecting end of each shielding member 16, 20 on a connecting portion 122 of the electrode platform 120 correspondingly.

In this embodiment, the invention disposes glue 40 on the supporting base 12 first and then stacks the primary winding 14 on the supporting base 12. When the primary winding 14 is stacked on the supporting base 12, two winding ends 140 of the primary winding 14 are disposed on two connecting portions 122 of the electrode platform 120 correspondingly. Then, the invention welds the winding ends 140 of the primary winding 14 on the connecting portions 122 of the electrode platform 120 by a spot welding process. In this embodiment, a height or position of the contact surface 124 of the connecting portion 122 is substantially identical to a height or position of the winding end 140, such that the winding end 140 extends to the contact surface 124 of the connecting portion 122 horizontally. Accordingly, when welding the winding end 140, the invention can enhance welding strength and prevent the winding end 140 from breaking.

Then, the invention disposes glue 42 on the primary winding 14 and then stacks the insulation member 26 on the primary winding 14. Then, the invention disposes glue 44 on the insulation member 26 and then stacks the shielding member 16 on the insulation member 26. When the shielding member 16 is stacked on the insulation member 26, a connecting end 160 of the shielding member 16 is disposed on the connecting portion 122 of the electrode platform 120 correspondingly. Then, the invention welds the connecting end 160 of the shielding member 16 on the connecting portion 122 of the electrode platform 120 by a hot pressure welding process. In this embodiment, a height or position of the contact surface 124 of the connecting portion 122 is substantially identical to a height or position of the connecting end 160, such that the connecting end 160 extends to the contact surface 124 of the connecting portion 122 horizontally. Accordingly, when welding the connecting end 160, the invention can enhance welding strength and prevent the connecting end 160 from breaking. The hot pressure welding process and the spot welding process can be laser welding or heating welding by heating the contact surface 124 of the connecting portion 122 of the electrode platform 120 with the winding end of the winding or the connecting end of shielding member correspondingly. Furthermore, the hot pressure welding process and the spot welding process can be changed with each other.

Then, the invention disposes glue 46 on the shielding member 16 and then stacks the insulation member 28 on the shielding member 16. Then, the invention disposes glue 48 on the insulation member 28 and then stacks the secondary winding 18 on the insulation member 28. Then, the invention disposes glue 50 on the secondary winding 18 and then stacks the insulation member 30 on the secondary winding 18. Then, the invention disposes glue 52 on the insulation member 30 and then stacks the shielding member 20 on the insulation member 30. When the shielding member 20 is stacked on the insulation member 30, a connecting end 200 of the shielding member 20 is disposed on the connecting portion 122 of the electrode platform 120 correspondingly. Then, the invention welds the connecting end 200 of the shielding member 20 on the connecting portion 122 of the electrode platform 120 by a hot pressure welding process. In this embodiment, a height or position of the contact surface 124 of the connecting portion 122 is substantially identical to a height or position of the connecting end 200, such that the connecting end 200 extends to the contact surface 124 of the connecting portion 122 horizontally. Accordingly, when welding the connecting end 200, the invention can enhance welding strength and prevent the connecting end 200 from breaking.

Then, the invention disposes glue 54 on the shielding member 20 and then stacks the insulation member 32 on the shielding member 20. Then, the invention disposes glue 56 on the insulation member 32 and then stacks the primary winding 22 on the insulation member 32. When the primary winding 22 is stacked on the supporting base 12, two winding ends 220 of the primary winding 22 are bent to be disposed on the connecting portions 122 of the electrode platform 120 correspondingly. Then, the invention welds the winding ends 220 of the primary winding 22 on the connecting portions 122 of the electrode platform 120 by a spot welding process.

Then, the invention disposes glue 58 on the primary winding 22 and then stacks the insulation member 34 on the primary winding 22. Then, the invention disposes glue 60 on the insulation member 34 and then stacks the auxiliary winding 24 on the insulation member 34. When the auxiliary winding 24 is stacked on the insulation member 34, two winding ends 240 of the auxiliary winding 24 are disposed on two connecting portions 122 of the electrode platform 120 correspondingly. Then, the invention welds the winding ends 240 of the auxiliary winding 24 on the connecting portions 122 of the electrode platform 120 by a spot welding process. In this embodiment, a height or position of the contact surface 124 of the connecting portion 122 is substantially identical to a height or position of the winding end 240, such that the winding end 240 extends to the contact surface 124 of the connecting portion 122 horizontally. Accordingly, when welding the winding end 240, the invention can enhance welding strength and prevent the winding end 240 from breaking.

Then, the invention disposes glue 62 on the auxiliary winding 24 and then stacks the insulation member 36 on the auxiliary winding 24.

Through the aforesaid process, the windings 14, 18, 22, 24, the shielding members 16, 20 and the insulation members 26, 28, 30, 32, 34, 36 are stacked on the supporting base 12 interlacedly, as shown in FIGS. 4 and 5. Then, the invention may cure the glue 40, 42, 44, 46, 48, 50, 52, 54, 56, 58, 60, 62, such that the windings 14, 18, 22, 24, the shielding members 16, 20 and the insulation members 26, 28, 30, 32, 34, 36 are adhered with each other on the supporting base 12 by the glue 40, 42, 44, 46, 48, 50, 52, 54, 56, 58, 60, 62.

Then, the invention fixes the winding ends 140, 220, 240 of the windings 14, 22, 24 and the connecting ends 160, 200 of the shielding members 16, 20 on the connecting portions 122 of the electrode platform 120 by solder 64, as shown in FIG. 6. The soldering material may be conductive alloy materials such as tin-gold (SnAu), tin-silver alloy (SnAg), tin-silver-copper alloy (SnAgCu), etc.

After step S12 shown in FIG. 8, step S14 shown in FIG. 8 is performed to dispose the supporting base 12 in the accommodating space 100 of the first core 10, such that the supporting base 12, the windings 14, 18, 22, 24, the shielding members 16, 20 and the insulation members 26, 28, 30, 32, 34, 36 all are disposed in the accommodating space 100 of the first core 10, as shown in FIG. 7.

In this embodiment, the first core 10 may have a pillar 102 located in the accommodating space 100 and the supporting base 12 may have a hollow tube portion 130 and a base portion 131 to form a T-shaped cross section. In some embodiments, the second core 38 may have a pillar (not shown) located in the accommodating space 100 and assembled with the first core 10. When the supporting base 12 is disposed in the accommodating space 100 of the first core 10, the hollow tube portion 130 is sleeved on the pillar 102. Furthermore, an outer diameter D1 of the hollow tube portion 130 is smaller than an inner diameter D2 of each winding 14, 18, 22, 24 and each shielding member 16, 20 and smaller than an inner diameter D3 of each insulation member 26, 28, 30, 32, 34, 36. In other words, there is no stop plate disposed on the top end of the hollow tube portion 130, such that the windings 14, 18, 22, 24, the shielding members 16, 20 and the insulation members 26, 28, 30, 32, 34, 36 can be sleeved on the hollow tube portion 130 from top to bottom interlacedly.

After step S14 shown in FIG. 8, step S16 shown in FIG. 8 is performed to dispose the second core 38 on the first core 10. When the second core 38 is disposed on the first core 10, the second core 38 covers the accommodating space 100 of the first core 10, as shown in FIG. 1. Through the aforesaid process, the manufacture of the magnetic component 1 of the invention is finished. In this embodiment, the first core 10 and second core 38 are formed as E-I type. However, besides the E-I type, the first core 10 and second core 38 may also be formed as F-L type, T-U type, E-E type or T-I type according to practical applications.

As shown in FIG. 4, the winding ends 140, 220 of the primary windings 14, 22 and the winding ends 180 of the secondary winding 18 are oriented towards opposite directions, so as to prevent the winding ends 140, 220 of the primary windings 14, 22 from crossing with the winding ends 180 of the secondary winding 18. Furthermore, the winding ends 140, 220, 240 of the windings 14, 22, 24 and the connecting ends 160, 200 of the shielding members 16, 20 are also interlaced with each other, so as to prevent magnetic coupling (induction) efficiency and reduce magnetic flux leakage between the winding ends 140, 220, 240 of the windings 14, 22, 24 and the connecting ends 160, 200 of the shielding members 16, 20 with each other.

In this embodiment, the winding ends 140, 220, 240 of the windings 14, 22, 24 and the connecting ends 160, 200 of the shielding members 16, 20 may be connected to the connecting portions 122 of the electrode platform 120 by solder and welding simultaneously, so as to enhance connection reliability. However, in another embodiment, the connection may be implemented by solder or welding alternatively, so as to reduce cost of automation machine and enhance manufacture rate.

As shown in FIG. 5, an outer diameter D4 of each insulation member 26, 28, 30, 32, 34, 36 is larger than an outer diameter D5 of each winding 14, 18, 22, 24 and each shielding member 16, 20, and an inner diameter D3 of each insulation member 26, 28, 30, 32, 34, 36 is smaller than an inner diameter D2 of each winding 14, 18, 22, 24 and each shielding member 16, 20, such that the insulation members 26, 28, 30, 32, 34, 36 can provide better insulating effect between the windings 14, 18, 22, 24 and the shielding members 16, 20 with each other. Preferably, a distance D7 between an outer edge of each insulation member 26, 28, 30, 32, 34, 36 and an outer edge of each winding 14, 18, 22, 24 and each shielding member 16, 20 may be larger than or equal to 0.2 mm, and a distance D8 between an inner edge of each insulation member 26, 28, 30, 32, 34, 36 and an inner edge of each winding 14, 18, 22, 24 and each shielding member 16, 20 may be larger than or equal to 0.2 mm, so as to enhance the insulating effect i.e. increase insulation resistance or withstanding voltage (e.g. larger than 3 kV).

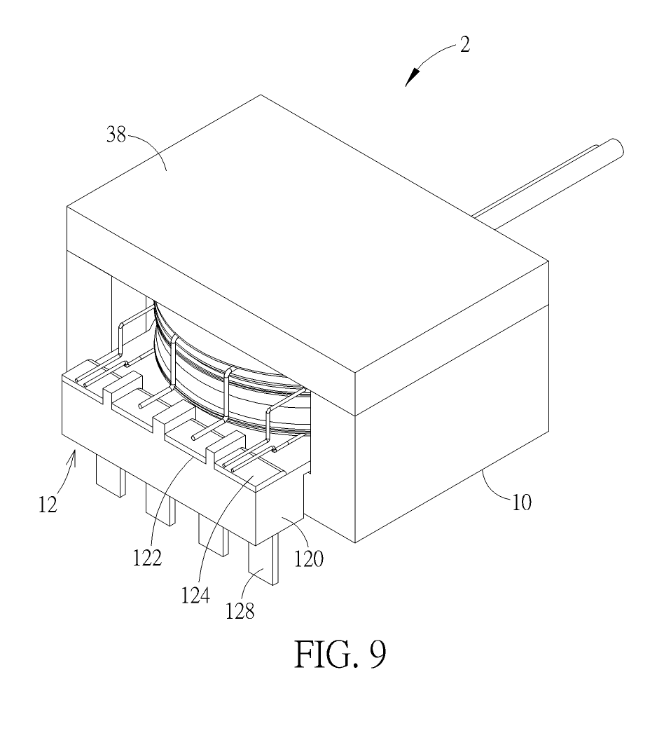

Referring to FIG. 9, FIG. 9 is a perspective view illustrating a magnetic component 2 according to another embodiment of the invention. The main difference between the magnetic component 2 and the aforesaid magnetic component 1 is that the connecting portions 122 of the electrode platform 120 of the magnetic component 2 are arranged in a planar type, such that the heights of the connecting portions 122 are substantially the same, as shown in FIG. 9.

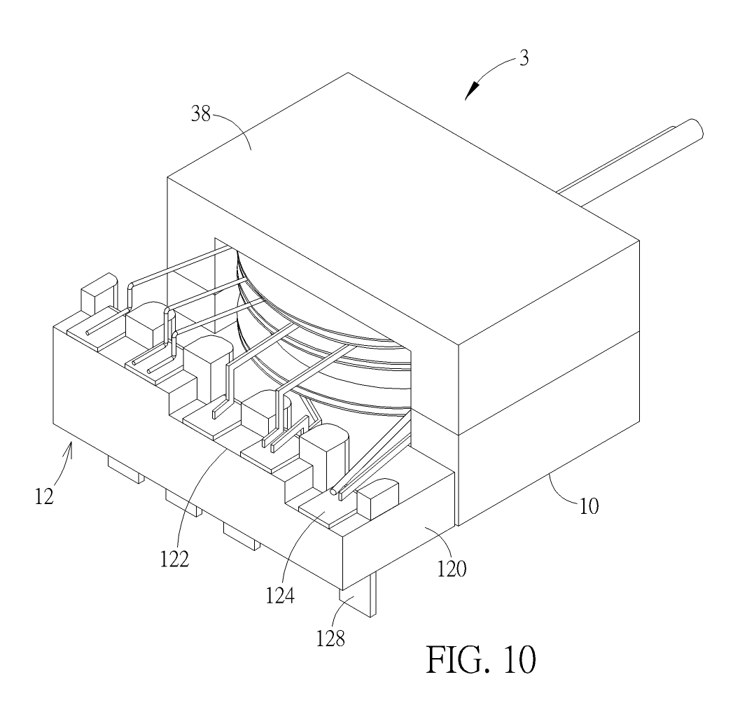

Referring to FIG. 10, FIG. 10 is a perspective view illustrating a magnetic component 3 according to another embodiment of the invention. The main difference between the magnetic component 3 and the aforesaid magnetic component 1 is that the connecting portions 122 of the electrode platform 120 of the magnetic component 3 are arranged in a step-shaped type, such that the heights of the connecting portions 122 vary gradually, as shown in FIG. 10.

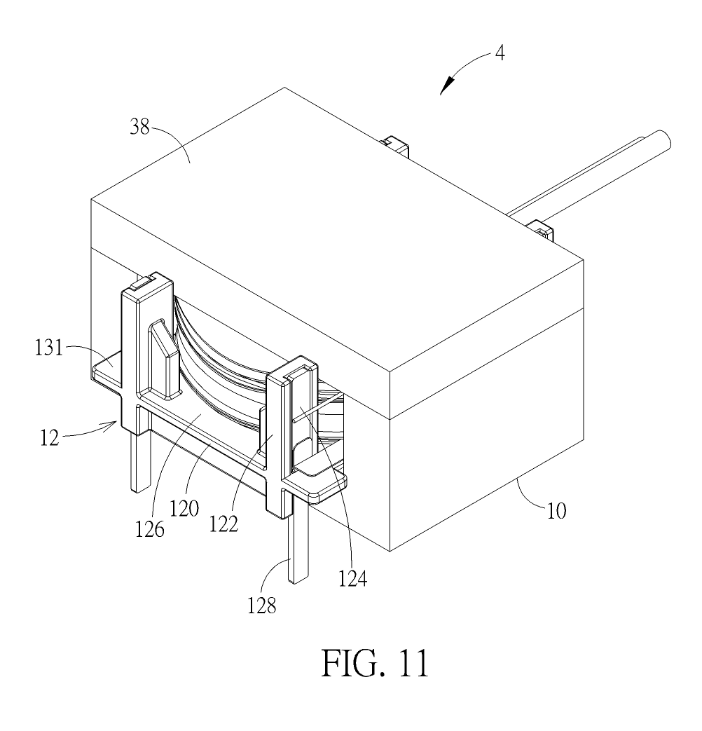

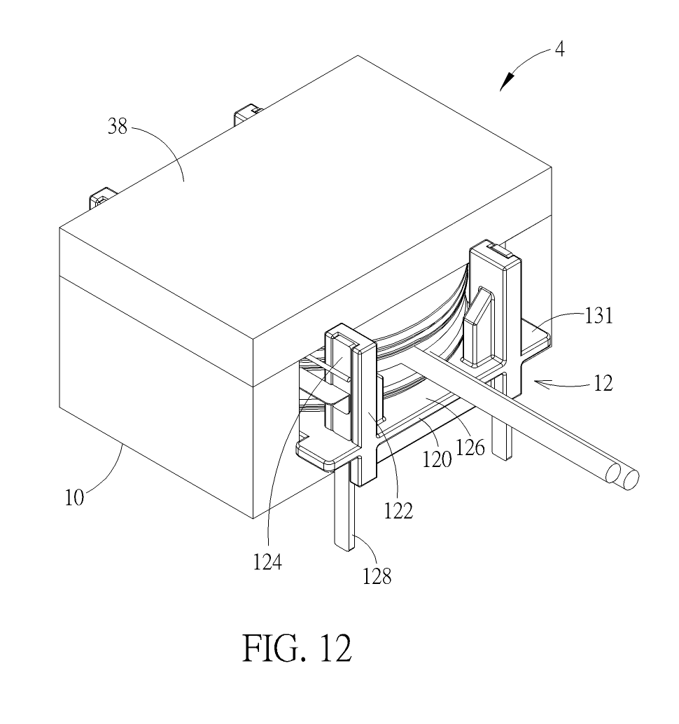

Referring to FIGS. 11 and 12, FIG. 11 is a perspective view illustrating a magnetic component 4 according to another embodiment of the invention and FIG. 12 is a perspective view illustrating the magnetic component 4 shown in FIG. 11 from another viewing angle. The main difference between the magnetic component 4 and the aforesaid magnetic component 1 is that the connecting portions 122 of the electrode platform 120 of the magnetic component 4 are arranged in a side type, such that the contact surface 124 of the connecting portion 122 is (not parallel to) extended in a direction away from a bottom surface 126 of the base portion 131 of the supporting base 12 to top. For example, as shown in FIGS. 11 and 12, the contact surface 124 of the connecting portion 122 may be perpendicular to the bottom surface 126 of the supporting base 12. In this embodiment, two connecting portions 122 are disposed at one side of the supporting base 12 and the other two connecting portions 122 are disposed at the other side of the supporting base 12.

According to the embodiments shown in FIGS. 1 and 9-12, the connecting portions 122 of the electrode platform 120 of the invention maybe arranged in a planar type, a T-shaped type, a step-shaped type or a side type according to practical applications.

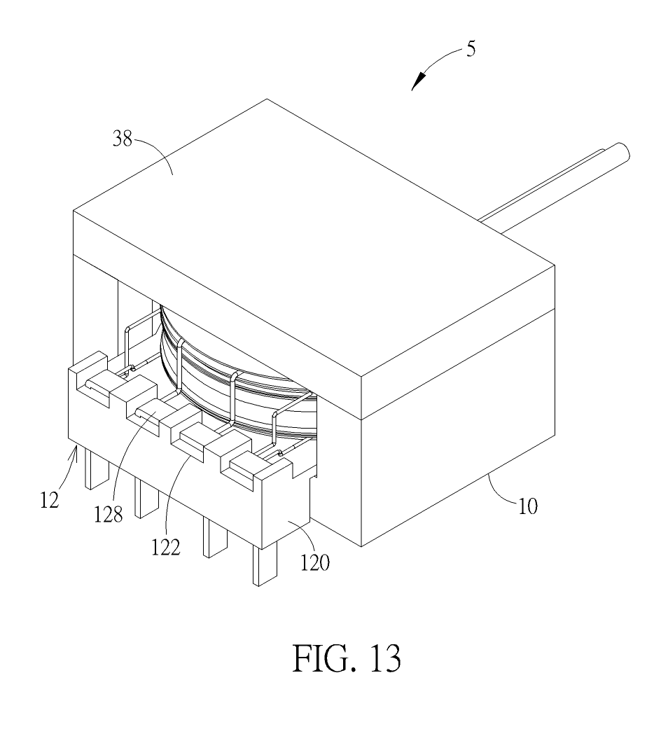

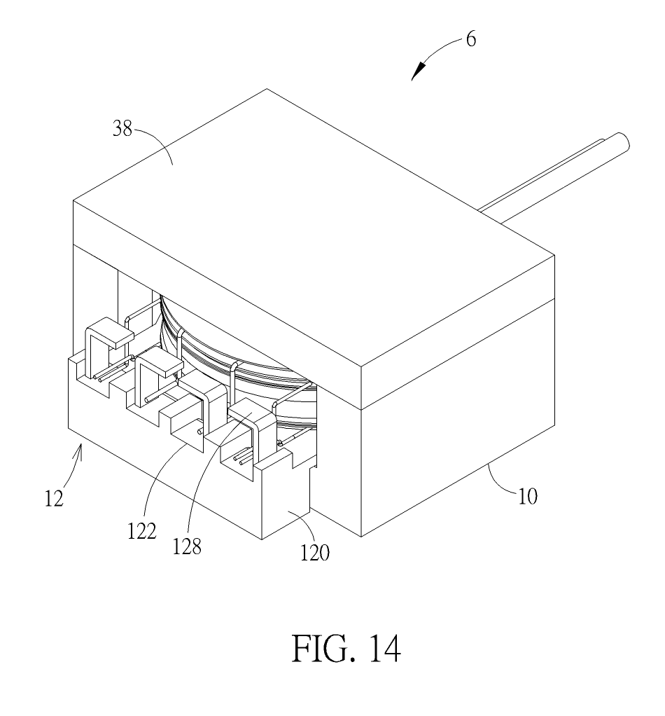

Referring to FIGS. 13 and 14, FIG. 13 is a perspective view illustrating a magnetic component 5 according to another embodiment of the invention and FIG. 14 is a perspective view illustrating the magnetic component 5 shown in FIG. 13 before the pins 128 are pressed downwardly. The main difference between the magnetic component 5 and the aforesaid magnetic component 1 is that, in the magnetic component 5, the winding ends of the windings are fixed on the connecting portions 122 of the electrode platform 120 by a mechanical manner. In this embodiment, the winding ends of the windings are located below the contact surface 124 of the connecting portion 122 or between top surface of the pins 128 and the bottom surface 126 of the supporting base 12 correspondingly. As shown in FIGS. 13 and 14, when a winding is stacked on the supporting base 12, the invention may use a pin 128 to fix the winding end of the winding by a mechanical manner. Then, the invention may further fix the winding end of the winding on the connecting portion 122 of the electrode platform 120 by solder.

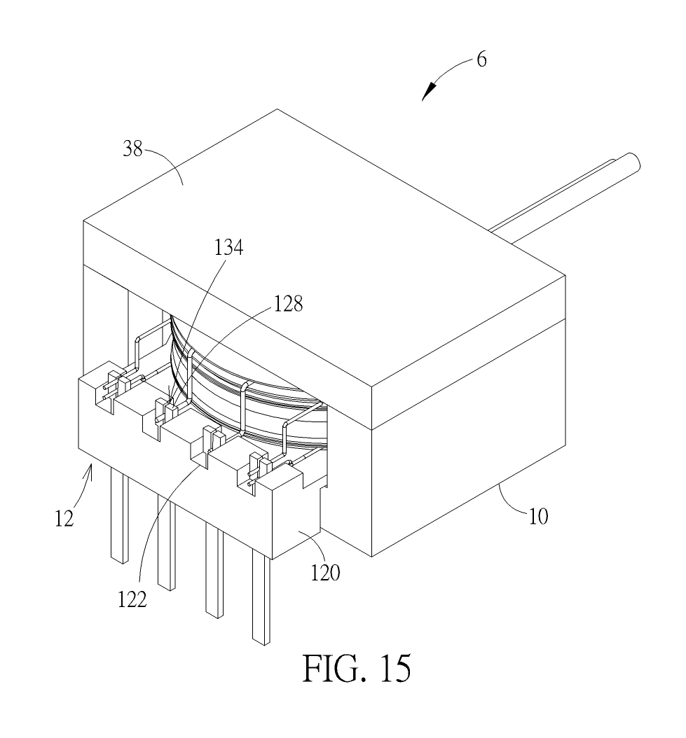

Referring to FIG. 15, FIG. 15 is a perspective view illustrating a magnetic component 6 according to another embodiment of the invention. The main difference between the magnetic component 6 and the aforesaid magnetic component 1 is that the pin 128 of the connecting portion 122 of the magnetic component 6 has an engaging groove 134 and the winding end of each winding is engaged in the engaging groove 134. As shown in FIG. 15, when a winding is stacked on the supporting base 12, the winding end of the winding is engaged in the engaging groove 134 and cut by the engaging groove 134 or other cutting devices by a mechanical manner. Then, the invention may further fix the winding end of the winding in engaging groove 134 by solder.

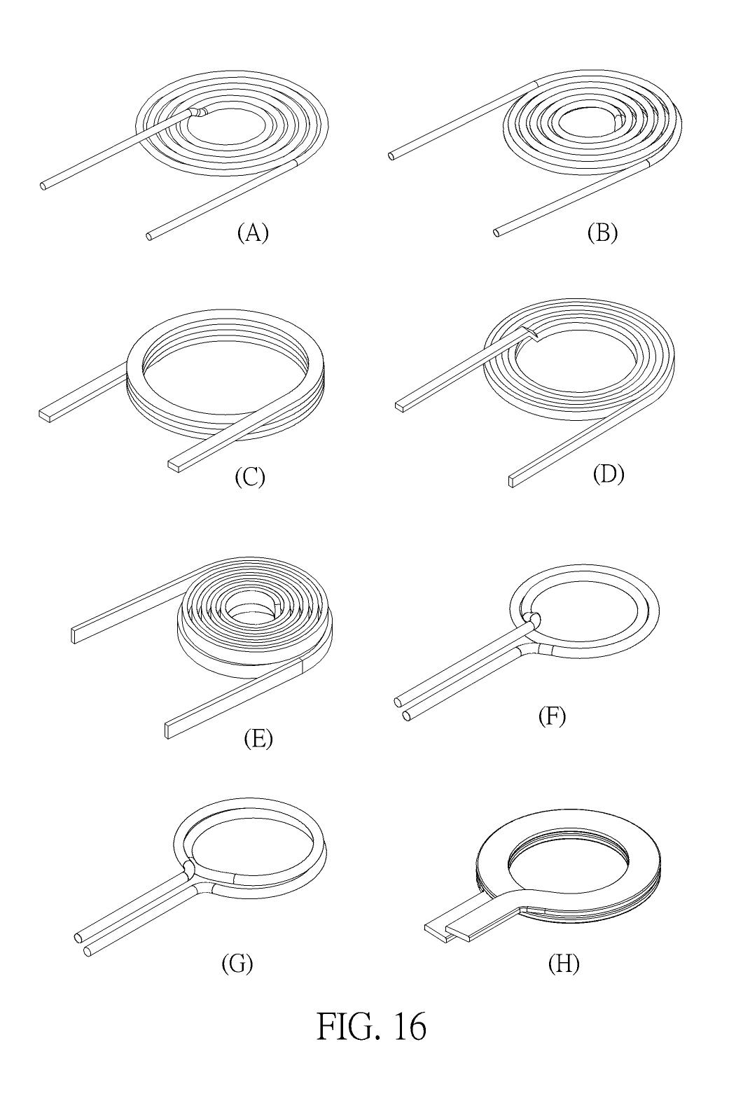

Referring to FIG. 16, FIG. 16 is a schematic view illustrating eight types of windings. As shown in FIGS. 16(A) to 16(E), the aforesaid primary windings 14, 22, shielding members 16, 20 and auxiliary winding 24 may be designed in different types according to practical applications. For example, the windings 14, 22, 24 and the shielding members 16, 20 may be made of a circular wire with multiple spirals and single layer (as shown in FIG. 16(A)), made of a circular wire with multiple spirals and multiple layers (as shown in FIG. 16(B)), made of a flat wire with single spiral and multiple layers (as shown in FIG. 16(C)), made of a flat wire (rectangular cross section) with multiple spirals and single layer (as shown in FIG. 16(D)), or made of a flat wire with multiple spirals and multiple layers (as shown in FIG. 16(E)). Furthermore, the windings 14, 22, 24 and the shielding members 16, 20 may be an internal and external winding (as shown in FIGS. 16(A) and 16(D)) or an external and external winding (as shown in FIGS. 16(B), 16(C) and 16(E)). Moreover, for the windings shown in FIGS. 16(A), 16(B), 16(D), 16(E), a number of horizontal turns (spiral) of the winding are larger than a number of vertical turns (layer) of the winding.

Furthermore, as shown in FIGS. 16(F) to 16(H), the aforesaid secondary winding 18 may be designed in different types according to practical applications. For example, the winding 18 may be an internal and external winding (as shown in FIG. 16(F)), an external and external winding (as shown in FIG. 16(G)), or an edgewise winding (as shown in FIG. 16(H)). When the primary windings 14, 22, secondary winding 18, shielding members 16, 20 or auxiliary winding 24 are selectively designed in the types of windings shown in FIGS. 16(A) to 16(H), the primary windings 14, 22, secondary winding 18, shielding members 16, 20 and auxiliary winding 24 can be stacked with each other easily, and cost-effective manufacturing and the total height of the magnetic component can be reduced.

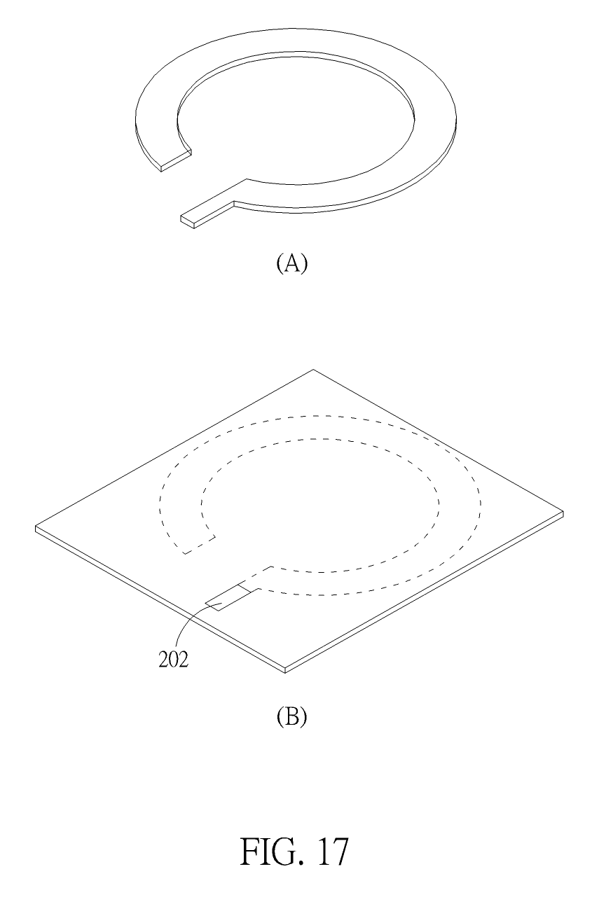

Referring to FIG. 17, FIG. 17 is a schematic view illustrating two types of shielding members. As shown in FIGS. 17(A) and 17(B), besides the windings shown in FIGS. 16(A) to 16(E), the aforesaid shielding members 16, 20 may also be formed by a copper foil through a punching process (as shown in FIG. 17(A)) or formed by a printed circuit board (as shown in FIG. 17(B)).

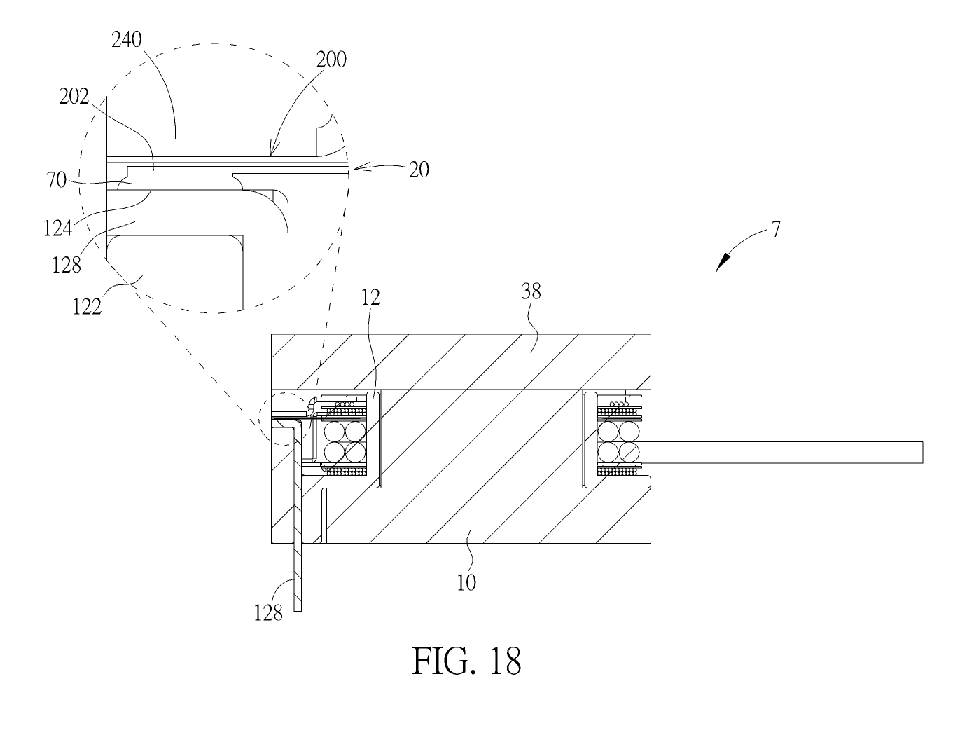

Referring to FIG. 18, FIG. 18 is a cross-sectional view illustrating a magnetic component 7 according to another embodiment of the invention. The main difference between the magnetic component 7 and the aforesaid magnetic component 1 is that the shielding member 20 of the magnetic component 7 is formed by a printed circuit board, such that the connecting end 200 of the shielding member 20 has a contact pad 202. In this embodiment, the contact pad 202 maybe fixed on the pin 128 by solder 70 when the shielding member 20 is stacked on the supporting base 12, such that the contact pad 202 is electrically connected to the contact surface 124 of the pin 128 of connecting portion 122. In some embodiments, the windings may be implemented by printed circuit board (PCB). Similarly, the winding ends of the windings have contact pads facing the connecting portion. The contact pads of the winding ends of the windings may be fixed on the pin by solder such that the contact pads are electrically connected to the contact surfaces of the pins of connecting portion.

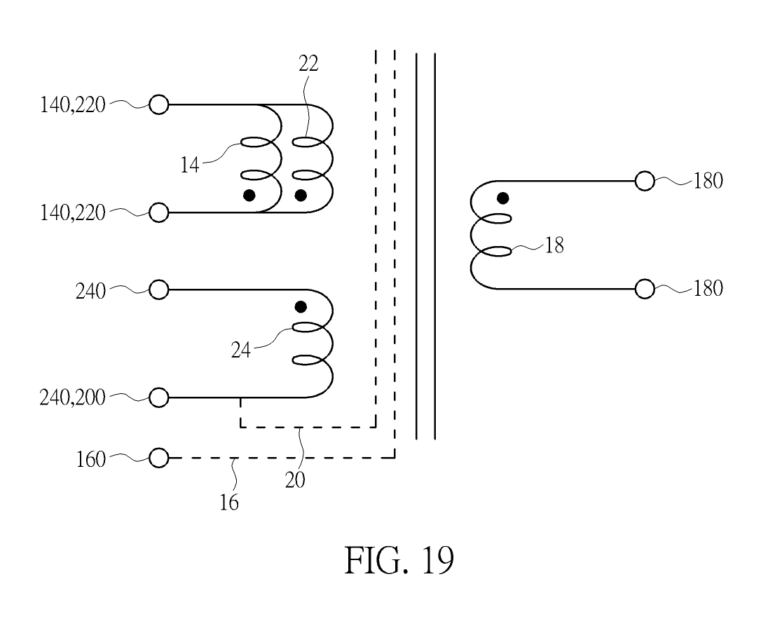

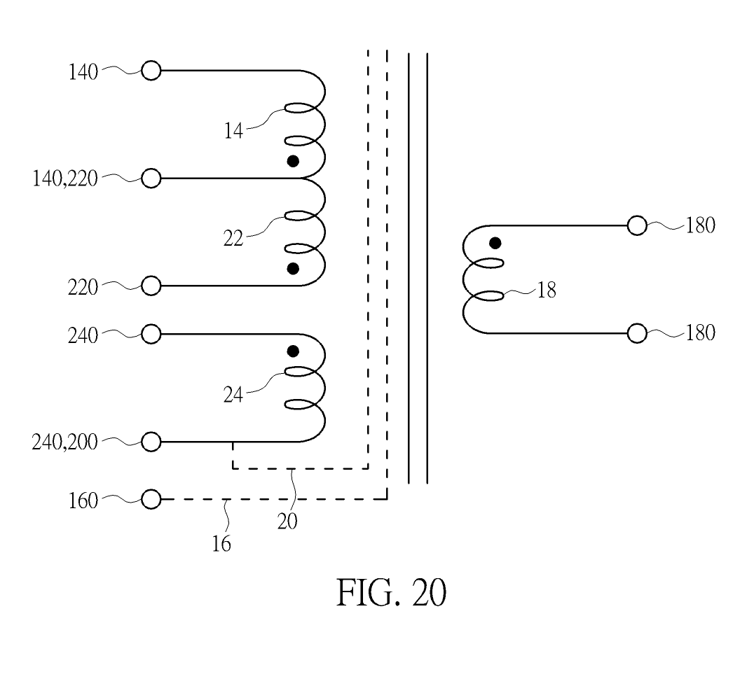

Referring to FIGS. 19 and 20, FIG. 19 is an equivalent circuit schematic illustrating the primary windings 14, 22 connected in parallel and FIG. 20 is an equivalent circuit schematic illustrating the primary windings 14, 22 connected in series. As shown in FIG. 19, the primary windings 14, 22 of the invention may be connected in parallel. As shown in FIG. 20, the primary windings 14, 22 of the invention maybe connected in series. Therefore, the primary windings 14, 22 of the invention may be connected in parallel or in series according to practical applications.

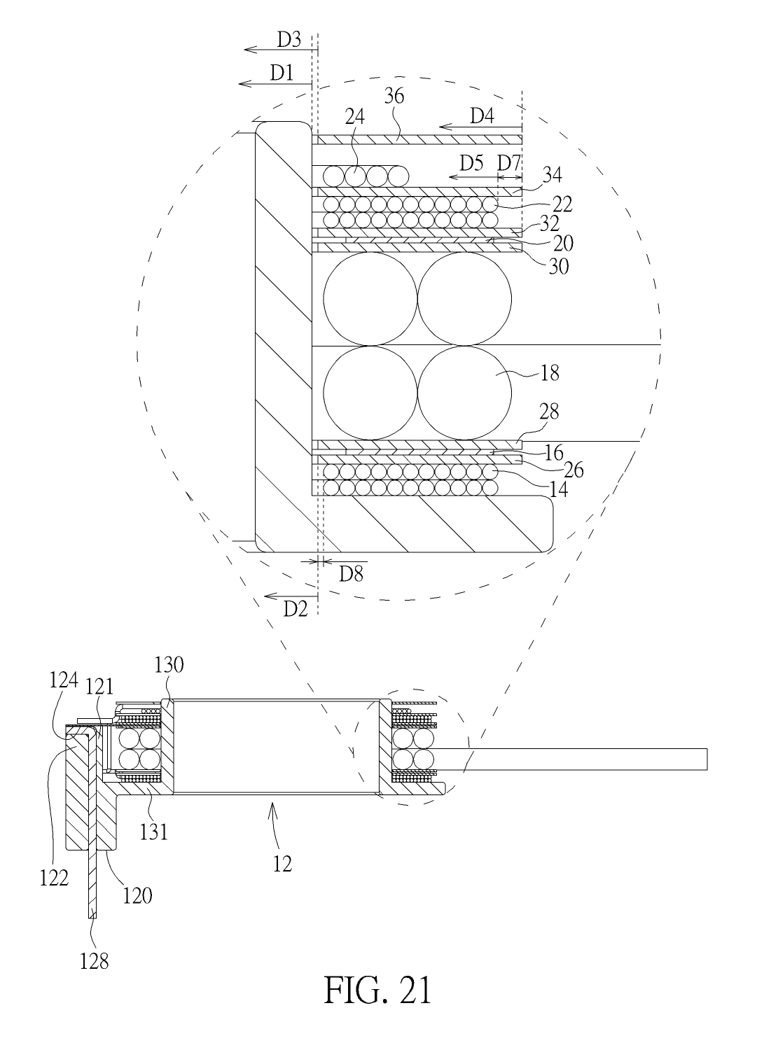

Referring to FIG. 21, FIG. 21 is a cross-sectional view illustrating the windings 14, 18, 22, 24, the shielding members 16, 20 and the insulation members 26, 28, 30, 32, 34, 36 stacked on the supporting base 12 interlacedly according to another embodiment of the invention. The main difference between this embodiment shown in FIG. 21 and the aforesaid embodiment shown in FIG. 5 is that the electrode platform 120 shown in FIG. 21 further has a block wall 121, such that the pin 128 is sandwiched in between the connecting portion 122 and the block wall 121. In this embodiment, the block wall 121 can further enhance insulation effect for the magnetic component.

It should be noted that the windings of the invention may be implemented by printed circuit board (PCB). However, if the turns ratio of the primary winding to the second winding increases, the number of layers of the winding have to increase, such that the manufacture cost increases. Therefore, if the turns ratio is large (e.g. larger than 16:1 or 20:1), the windings of the invention may be implemented by wire, so as to reduce the manufacture cost effectively.

As mentioned in the above, the invention disposes the supporting base in the accommodating space of the core and stacks the winding and the insulation member on the supporting base interlacedly. Since the winding and the insulation member are stacked on the supporting base rather than being wound around the pillar of the core, the winding and the insulation member can be formed in advance and the magnetic component of the invention can be manufactured automatically. Furthermore, when the winding is stacked on the supporting base, the winding end of the at least one winding is disposed and fixed on the connecting portion of the electrode platform, so as to form an electrical connection. Since the winding end of the winding is disposed and fixed on the connecting portion of the electrode platform to form an electrical connection, automation of manufacturing the magnetic component can be achieved easily and effectively. Consequently, the manufacture cost can decrease and the manufacture efficiency can increase.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A magnetic component comprising:
a first core having an accommodating space;
a supporting base disposed in the accommodating space, the supporting base having an electrode platform;
at least one winding disposed in the accommodating space and stacked on the supporting base, a winding end of the at least one winding being disposed on a connecting portion of the electrode platform;
at least one insulation member disposed in the accommodating space and stacked on the at least one winding; and
a second core disposed on the first core and covering the accommodating space.

2. The magnetic component of claim 1, wherein an outer diameter of the at least one insulation member is larger than an outer diameter of the at least one winding, and an inner diameter of the at least one insulation member is smaller than an inner diameter of the at least one winding.

3. The magnetic component of claim 2, wherein a distance between an outer edge of the at least one insulation member and an outer edge of the at least one winding is larger than or equal to 0.2 mm, and a distance between an inner edge of the at least one insulation member and an inner edge of the at least one winding is larger than or equal to 0.2 mm.

4. The magnetic component of claim 1, wherein the electrode platform comprises a plurality of connecting portions, the connecting portions are arranged in a planar type, a T-shaped type or a step-shaped type, such that a contact surface of the connecting portion is parallel to a bottom surface of the supporting base.

5. The magnetic component of claim 1, wherein the electrode platform comprises a plurality of connecting portions, the connecting portions are arranged in a side type, such that a contact surface of the connecting portion is extended in a direction away from a bottom surface of the supporting base.

6. The magnetic component of claim 1, wherein the winding end of the at least one winding is bent to be disposed on the connecting portion of the electrode platform.

7. The magnetic component of claim 1, wherein the connecting portion has an engaging groove and the winding end of the at least one winding is engaged in the engaging groove.

8. The magnetic component of claim 1, wherein the connecting portion has a pin extending downwardly out of the first core.

9. The magnetic component of claim 1, wherein a number of horizontal turns of the at least one winding are larger than a number of vertical turns of the at least one winding.

10. The magnetic component of claim 1, wherein the at least one winding comprises a primary winding and a secondary winding, the magnetic component further comprises at least one shielding member, the shielding member is disposed between the primary winding and the secondary winding.

11. The magnetic component of claim 10, wherein the shielding member is formed by a printed circuit board, a connecting end of the shielding member has a contact pad, and the contact pad is electrically connected to a contact surface of the connecting portion when the shielding member is stacked on the supporting base.

12. The magnetic component of claim 10, wherein the at least one insulation member is disposed between the primary winding, the secondary winding and the shielding member.

13. The magnetic component of claim 1, wherein the first core or the second core has a pillar located in the accommodating space, the supporting base has a hollow tube portion and a base portion to form a T-shaped cross section, the hollow tube portion is sleeved on the pillar, an outer diameter of the hollow tube portion is smaller than an inner diameter of the at least one winding and smaller than an inner diameter of the at least one insulation member, and the at least one winding and the at least one insulation member are sleeved on the hollow tube portion.

14. The magnetic component of claim 1, wherein a height of a contact surface of the connecting portion is substantially identical to a height of the winding end, such that the winding end extends to the contact surface of the connecting portion horizontally.

15. The magnetic component of claim 1, wherein the connecting portion protrudes from the electrode platform upwardly.

16. A method of manufacturing a magnetic component comprising:
providing a first core, a supporting base, at least one winding, at least one insulation member and a second core, wherein the first core has an accommodating space and the supporting base has an electrode platform;
stacking the at least one winding and the at least one insulation member on the supporting base interlacedly and disposing a winding end of the at least one winding on a connecting portion of the electrode platform;
disposing the supporting base in the accommodating space; and
disposing the second core on the first core, wherein the second core covers the accommodating space.

17. The method of claim 16, further comprising:
connecting the winding end of the at least one winding to the connecting portion of the electrode platform by solder or welding.

18. The method of claim 17, further comprising:
welding the winding end of the at least one winding on the connecting portion of the electrode platform; and
fixing the winding end of the at least one winding on the connecting portion of the electrode platform by solder.

19. The method of claim 17, further comprising:
fixing the winding end of the at least one winding on the connecting portion of the electrode platform by a mechanical manner; and
fixing the winding end of the at least one winding on the connecting portion of the electrode platform by solder.

20. The method of claim 16, further comprising:
adhering the at least one winding and the at least one insulation member by glue.

21. The method of claim 16, wherein the electrode platform comprises a plurality of connecting portions, the connecting portions are arranged in a planar type, a T-shaped type or a step-shaped type, such that a contact surface of the connecting portion is parallel to a bottom surface of the supporting base.

22. The method of claim 16, wherein the electrode platform comprises a plurality of connecting portions, the connecting portions are arranged in a side type, such that a contact surface of the connecting portion is not parallel to a bottom surface of the supporting base.

23. The method of claim 16, wherein a number of horizontal turns of the at least one winding are larger than a number of vertical turns of the at least one winding.

24. The method of claim 16, wherein the first core or the second core has a pillar located in the accommodating space, the supporting base has a hollow tube portion and a base portion to form a T-shaped cross section, the hollow tube portion is sleeved on the pillar, an outer diameter of the hollow tube portion is smaller than an inner diameter of the at least one winding and smaller than an inner diameter of the at least one insulation member, and the at least one winding and the at least one insulation member are sleeved on the hollow tube portion.
